(19) United States
(12) Patent Application Publication
(10) Pub. No.: US 2010/0182722 A1
(43) Pub. Date: Jul. 22, 2010

(54) PERPENDICULAR MAGNETIC STORAGE MEDIUM AND MULTILAYERED STRUCTURE FILM AND STORAGE DEVICE

(75) Inventor: Ryoichi MUKAI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/632,469

(22) Filed: Dec. 7, 2009

(30) Foreign Application Priority Data
Dec. 8, 2008 (JP) 2008-312619

(51) Int. Cl. G11B 21/16; G11B 5/82

(52) U.S. Cl. 360/246.2; 360/135; G9B/5.293; G9B/21.023

(57) ABSTRACT

A second thin film having a second thickness is overlaid on a first thin film having a first thickness in a first laminate unit. The first thin film is made of nonmagnetic noble metal atoms. The second thin film is made of magnetic atoms. A fourth thin film having a fourth thickness different from the second thickness is overlaid on a third thin film having a third thickness different from the first thickness in a second laminate unit. The third thin film is made of the nonmagnetic noble metal atoms. The fourth thin film is made of the magnetic atoms. The total saturation magnetization Ms and the total anisotropic magnetic field Hk can be adjusted by changing the numbers of the first and second thin films.

### CROSS-REFERENCE TO RELATED APPLICATION

This application is based upon and claims the benefit of priority from the prior Japanese Patent Application No. 2008-312619 filed on Dec. 8, 2008, the entire contents of which are incorporated herein by reference.

### FIELD

The present invention relates to a so-called perpendicular magnetic storage medium. In particular, the present invention relates to a multilayered structure film utilized in a perpendicular magnetic storage medium such as a bit patterned medium.

### BACKGROUND

A so-called bit patterned medium is well known. The bit patterned medium has lines of recording tracks concentrically extending on the surface of a magnetic recording layer. The individual recording track has magnetic pillars arranged in a line or lines, for example. A nonmagnetic body is utilized to magnetically insulate or isolate the magnetic pillars from one another. The magnetic recording layer is overlaid on a soft magnetic underlayer so as to realize perpendicular magnetic recording. The soft magnetic underlayer allows application of a magnetic field, leaking from a write head, through the magnetic recording layer in the direction perpendicular to the surface of the magnetic recording layer.

### [Publication 1] Japanese Patent Application Publication No. 6-052535

### [Publication 2] Japanese Patent Application Publication No. 2005-209303

A multilayered structure magnetic layer including a palladium layer or layers and a cobalt layer or layers is well known. The use of such a multilayered structure magnetic layer is proposed in the bit patterned medium. The use of the multilayered structure magnetic layer in the bit patterned medium requires a reduction in the thickness of the multilayered structure magnetic layer. A reduced thickness of the multilayered structure magnetic layer allows a magnetic field, leaking from a write head, to reliably reach the soft magnetic underlayer. An intense magnetic field can reliably be applied to the multilayered structure magnetic layer when data is written into the multilayered structure magnetic layer.

### SUMMARY

It is accordingly an object of the present invention to provide a multilayered structure film significantly contributing to a reduction in the thickness of a multilayered structure magnetic layer. It is also an object of the present invention to provide a perpendicular magnetic storage medium employing such a multilayered structure film.

According to an aspect of the invention, a multilayered structure film includes: a first laminate unit including a first thin film and a second thin film laminated on each other, the first thin film having a first thickness and made of nonmagnetic noble metal atoms, the second thin film having a second thickness and made of magnetic atoms or a magnetic alloy; and a second laminate unit overlaid on the first laminate unit, the second laminate unit including a third thin film and a fourth thin film laminated on each other, the third thin film having a third thickness different from the first thickness, the third thin film made of the nonmagnetic noble metal atoms, the fourth thin film having a fourth thickness different from the second thickness, the fourth thin film made of the magnetic atoms or the magnetic alloy.

The multilayered structure film enables establishment of the first laminate unit having the saturation magnetization and the anisotropic magnetic field different from the saturation magnetization and the anisotropic magnetic field, respectively, of the second laminate unit. The saturation magnetization and the anisotropic magnetic field of the entire multilayered structure film can be adjusted by changing the combination of the first laminate unit and the second laminate unit. The thicknesses of the thin films can be set on a basis of a discrete value, namely an increment or decrement value, equivalent to the dimension of the atoms. It is unnecessary to finely adjust the thicknesses of the thin films by a unit smaller than the dimension of atoms. Consequently, even when the thickness of the multilayered structure magnetic layer is reduced, the desired values of the saturation magnetization and anisotropic magnetic field can be obtained in a relatively facilitated manner.

The multilayered structure film can be utilized in a perpendicular magnetic storage medium. The perpendicular magnetic storage medium may include: a substrate; a soft magnetic underlayer overlaid on the surface of the substrate; a basement layer overlaid on the surface of the soft magnetic underlayer; a first laminate unit overlaid on the basement layer, the first laminate unit including a first thin film and a second thin film laminated on each other, the first thin film having a first thickness and made of nonmagnetic noble metal atoms, the second thin film having a second thickness and made of magnetic atoms or a magnetic alloy; and a second laminate unit overlaid on the first laminate unit, the second laminate unit including a third thin film and a fourth thin film laminated on each other, the third thin film having a third thickness different from the first thickness, the third thin film made of the nonmagnetic noble metal atoms, the fourth thin film having a fourth thickness different from the second thickness, the fourth thin film made of the magnetic atoms or the magnetic alloy.

The perpendicular magnetic storage medium can be utilized in a storage device. The storage device may include: a storage medium; and a head slider opposed to the surface of the storage medium, wherein the storage medium includes: a substrate; a soft magnetic underlayer overlaid on the surface of the substrate; a basement layer overlaid on the surface of the soft magnetic underlayer; a first laminate unit overlaid on the basement layer, the first laminate unit including a first thin film and a second thin film laminated on each other, the first thin film having a first thickness and made of nonmagnetic noble metal atoms, the second thin film having a second thickness and made of magnetic atoms or a magnetic alloy; and a second laminate unit overlaid on the first laminate unit, the second laminate unit including a third thin film and a fourth thin film laminated on each other, the third thin film having a third thickness different from the first thickness, the third thin film made of the nonmagnetic noble metal atoms, the fourth thin film having a fourth thickness different from the second thickness, the fourth thin film made of the magnetic atoms or the magnetic alloy.

The object and advantages of the embodiments will be realized and attained by means of the elements and combinations particularly pointed out in the appended claims. It is to be understood that both the foregoing general description and the following detailed description are exemplary and explanatory and are not restrictive of the embodiments, as claimed.

### BRIEF DESCRIPTION OF THE DRAWINGS

FIG. 1 is a plan view schematically illustrating a hard disk drive, HDD, as a specific example of a storage device;

FIG. 2 is an enlarged perspective view schematically illustrating the surface of a magnetic recording disk;

FIG. 3 is a sectional view taken along the line 3-3 in FIG. 2, for illustrating a magnetic recording disk according to a first embodiment;

FIG. 4 is an enlarged partial view of the sectional view of FIG. 3;

FIG. 5 is a sectional view, corresponding to FIG. 3, schematically illustrating a resist film formed on the surface of a second laminate unit in the process of making the second laminate unit arid a first laminate unit nonmagnetic;

FIG. 6 is a graph depicting the relationship between the numbers of layers in the first and second laminate units and the saturation magnetization and the relationship between the numbers of layers in the first and second laminate units and the anisotropic magnetic field;

FIG. 7 is a graph depicting the relationship between the numbers of layers in the first and second laminate units and the saturation magnetization and the relationship between the numbers of layers in the first and second laminate units and the anisotropic magnetic field; and

FIG. 8 is a sectional view, corresponding to FIG. 3, illustrating a magnetic recording disk according to a second embodiment.

### DESCRIPTION OF EMBODIMENTS

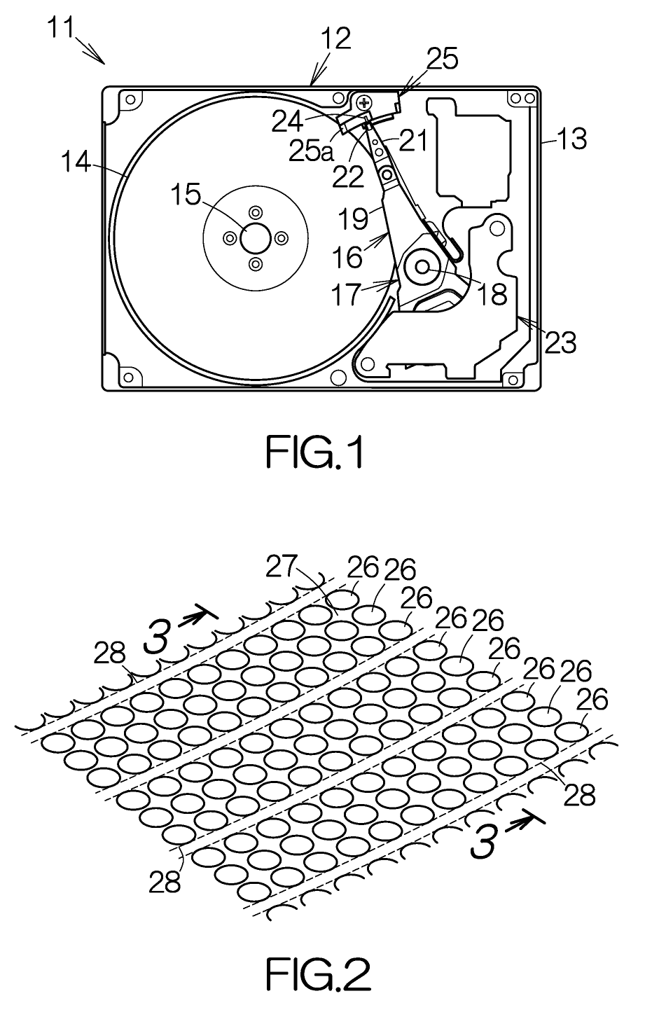

FIG. 1 schematically depicts the structure of a hard disk drive, HDD, 11 as an example of a storage medium drive or storage device. The hard disk drive 11 includes an enclosure 12. The enclosure 12 includes a box-shaped enclosure base 13 and an enclosure cover, not depicted. The box-shaped enclosure base 13 is configured to define an inner space in the shape of a flat parallelepiped, for example. The box-shaped enclosure base 13 may be made of a metallic material such as aluminum (Al), for example. Casting process may be employed to form the box-shaped enclosure base 13. The enclosure cover is coupled to the box-shaped enclosure base 13. The enclosure cover closes the opening of the box-shaped enclosure base 13 so as to establish a closed inner space. Pressing process may be employed to form the enclosure cover out of a plate material, for example.

At least one magnetic recording disk 14 as a storage medium is placed in the inner space of the box-shaped enclosure base 13. The magnetic recording disk or disks 14 are mounted on the driving shaft of a spindle motor 15. The spindle motor 15 drives the magnetic recording disk or disks 14 for rotation at a higher revolution speed such as 5,400 rpm, 7,200 rpm, 10,000 rpm, 15,000 rmp, or the like. Here, the magnetic recording disk 14 is configured as a so-called perpendicular magnetic storage medium, for example. The magnetic recording disk 14 will be described later in detail.

A carriage 16 is also placed in the inner space of the box-shaped enclosure base 13. The carriage 16 includes a carriage block 17. The carriage block 17 is coupled to a vertical pivotal shaft 18 for relative rotation. The vertical pivotal shaft 18 stands upright from the bottom plate of the box-shaped enclosure base 13. Carriage arms 19 are defined in the carriage block 17. The carriage arms 19 extend in the horizontal direction from the vertical pivotal shaft 18. The carriage block 17 may be made of aluminum (Al), for example. Extrusion process may be employed to form the carriage block 17, for example.

A head suspension 21 is attached to the front or tip end of the individual carriage arm 19. The head suspension 21 extends forward from the front end of the carriage arm 19. A flexure is attached to the head suspension 21. A flying head slider 22 is supported on the flexure. The flexure allows the flying head slider 22 to change its attitude relative to the head suspension 21. A head element, namely an electromagnetic transducer, not depicted, is mounted on the flying head slider 22.

The electromagnetic transducer includes a write element and a read element, for example. A so-called single pole head is employed as the write element. The single pole head generates a magnetic field with the assistance of a thin film coil pattern. A main magnetic pole and an auxiliary magnetic pole allow the magnetic flux to circulate between the single pole head and the magnetic recording disk 14. The magnetic field is in this manner guided in the perpendicular direction perpendicular to the surface of the magnetic recording disk 14. The magnetic field is utilized to write binary data into the magnetic recording disk 14. A giant magnetoresistive (GMR) element or a tunnel-junction magnetoresistive (TMR) element is employed as the read element. A variation in the electric resistance is induced in a spin valve film or a tunnel-junction film in response to the change of direction of the magnetic field applied from the magnetic recording disk 14, for example. The read element discriminates binary data on the magnetic recording disk 14 based on the induced variation in the electric resistance.

When the magnetic recording disk 14 rotates, the flying head slider 22 is allowed to receive airflow generated along the rotating magnetic recording disk 14. The airflow serves to generate a positive pressure or lift as well as a negative pressure on the flying head slider 22. The lift of the flying head slider 22 is balanced with the urging force of the head suspension 21 and the negative pressure so that the flying head slider 22 keeps flying above the surface of the magnetic recording disk 14 at a higher stability during the rotation of the magnetic recording disk 14.

A power source such as a voice coil motor, VCM, 23 is coupled to the carriage block 17. The voice coil motor 23 serves to drive the carriage block 17 around the vertical pivotal shaft 18. The rotation of the carriage block 17 allows the carriage arms 19 and the head suspensions 21 to swing. When the individual carriage arm 19 swings around the vertical pivotal shaft 18 during the flight of the flying head slider 22, the flying head slider 22 is allowed to move in the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

A load tab 24 is defined in the front or tip end of the individual head suspension 21. The load tab 24 extends further forward from the front end of the head suspension 21. The swinging movement of the carriage arm 19 allows the load tab 24 to move along the radial direction of the magnetic recording disk 14. A ramp member 25 is located on the movement path of the load tab 24 in a space outside the outer periphery of the magnetic recording disk or disks 14. The ramp member 25 is fixed to the box-shaped enclosure base 13. The load tab 24 is received on the ramp member 25. The ramp member 25 may be made of a hard plastic material, for example. Molding process may be employed to form the ramp member 25.

The ramp member 25 includes ramps 25a each extending along the movement path of the corresponding load tab 24. The ramp 25a gets farther from an imaginary plane including the corresponding surface of the magnetic recording disk or disks 14 as the position gets farther from the rotation axis of the magnetic recording disk 14. When the carriage arm 19 is driven to swing around the vertical pivotal shaft 18 to get farther from the rotation axis of the magnetic recording disk 14, the load tab 24 slides upward along the corresponding ramp 25a. The flying head slider 22 is in this manner distanced from the surface of the magnetic recording disk 14. The flying head slider 22 is unloaded into the space outside the outer contour of the magnetic recording disk 14. When the carriage arm 19 is driven to swing around the vertical pivotal shaft 18 to get closer to the rotation axis of the magnetic recording disk 14, the load tab 24 slides downward along the corresponding ramp 25a. The rotating magnetic recording disk 14 serves to generate a lift on the flying head slider 22. The ramp member 25 and the load tabs 24 in combination establish a so-called load/unload mechanism.

As depicted in FIG. 2, lines of magnetic dots 26 are concentrically arranged on the surface of the magnetic recording disk 14. The individual magnetic dot 26 is shaped in a column having the center axis perpendicular to the surface of the magnetic recording disk 14, for example. The column is named a magnetic pillar. The diameter of the magnetic pillar is set at 20 nm approximately, for example. The interval is set within a range from 22 nm to 23nm, approximately, between the center axes of the adjacent magnetic pillars, for example. A nonmagnetic body 27 is utilized to magnetically insulate or isolate the magnetic pillars from one another. Here, three lines of the magnetic pillars form one recording track 28, for example. Accordingly, the nonmagnetic body 27 serves to magnetically insulate or isolate the recording tracks 28 from one another. Moreover, the nonmagnetic body 27 also serves to magnetically insulate or isolate the adjacent ones of the magnetic pillars from one another on the individual line.

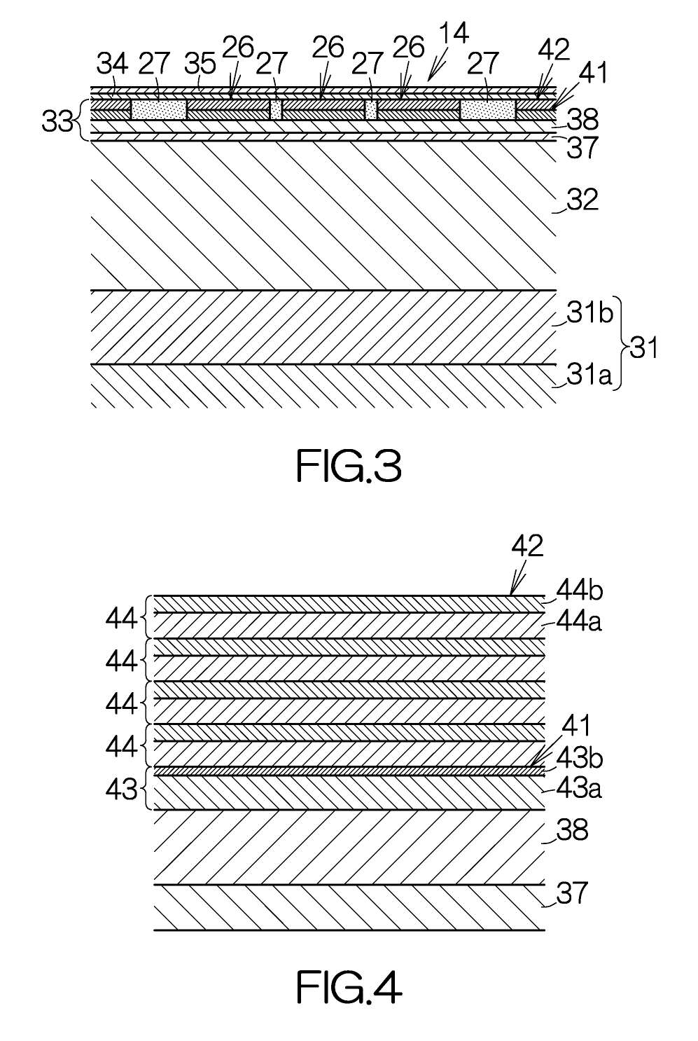

FIG. 3 depicts the structure of the magnetic recording disk 14 along a cross-section according to an embodiment of the present invention. The magnetic recording disk 14 includes a substrate 31. The substrate 31 may include a disk-shaped silicon (Si) main body 31a and amorphous SiO₂ films 31b respectively extending over the front and back surfaces of the disk-shaped silicon main body 31a, for example. Here, only the front surface of the disk-shaped silicon main body 31a is illustrated. It should be noted that a glass substrate or an aluminum substrate may alternatively be employed as the substrate 31.

A soft magnetic underlayer 32 extends on the surface of the substrate 31. The soft magnetic underlayer 32 may be made of a soft magnetic material such as an iron tantalum carbide (FeTaC) film, a nickel iron (NiFe) film, or the like. Here, an iron tantalum carbide film having the thickness of 300 [nm] approximately is employed, for example. The axis of easy magnetization is established in the soft magnetic underlayer 32 in the in-plane direction set parallel to the surface of the substrate 31.

A multilayered structure film 33 extends on the surface of the soft magnetic underlayer 32. Binary data or magnetic information is written into the multilayered structure film 33. The surface of the multilayered structure film 33 is coated with a protection film 34 such as a diamond like carbon (DLC) film and a lubricating agent film 35 such as a perfluoropolyether (PFPE) film, for example. It should be noted that the soft magnetic underlayer 32, the multilayered structure film 33, the protection film 34 and the lubricating agent film 35 are likewise overlaid on the back surface of the substrate 31 in this sequence.

The multilayered structure film 33 includes a tantalum (Ta) cohering layer 37 extending on the surface of the soft magnetic underlayer 32. The tantalum cohering layer 37 has the amorphous structure. The thickness of the tantalum cohering layer 37 is set at 2.0 [nm], for example. A palladium (Pd) basement layer 38 extends on the surface of the tantalum cohering layer 37. The palladium basement layer 38 has the polycrystalline structure. The adjacent crystal grains cohere to each other. The thickness of the palladium basement layer 38 is set smaller than 5.0 [nm]. Here, the thickness of the palladium basement layer 38 is set at 3.0 [nm].

The multilayered structure film 33 includes a first laminate unit 41 extending on the surface of the palladium basement layer 38. A second laminate unit 42 is overlaid on the first laminate unit 41. The second laminate unit 42 is received directly on the surface of the first laminate unit 41. The magnetic pillars are formed in the first and second laminate units 41, 42.

FIG. 4 depicts a specific example of the first and second laminate units 41, 42. The first laminate unit 41 includes at least one first double-layer structure film 43. The individual first double-layer structure film 43 includes a first thin film 43a and a second thin film 43b overlaid on the first thin film 43a. The first thin film 43a has a first thickness. The second thin film 43b has a second thickness. The second thin film 43b is received directly on the surface of the first thin film 43a. Nonmagnetic noble metal atoms form the first thin film 43a. Here, the nonmagnetic noble metal atoms are palladium (Pd) atoms, for example. The first thin film 43a thus is a palladium layer. Magnetic atoms form the second thin film 43b. Here, the magnetic atoms are cobalt (Co) atoms, for example. The second thin film 43b thus is a cobalt layer. Platinum (Pt) atoms may be employed in place of the palladium atoms. Iron (Fe) atoms may be employed in place of the cobalt atoms. Here, the first laminate unit 41 includes a single one of the first double-layer structure film 43. The cobalt layer, namely the second thin film 43b, having the thickness of 0.2 [nm] is overlaid directly on the surface of the palladium layer, namely the first thin film 43a, having the thickness of 0.8 [nm] in the first double-layer structure film 43.

The second laminate unit 42 includes at least one second double-layer structure film 44. The individual second double-layer structure film 44 includes a third thin film 44a and a fourth thin film 44b overlaid on the third thin film 44a. The third thin film 44a has a third thickness. The fourth thin film 44b has a fourth thickness. The fourth thin film 44b is received directly on the surface of the third thin film 44a. The third thickness differs from the first thickness. The fourth thickness differs from the third thickness. Nonmagnetic noble metal atoms form the third thin film 44a. Here, the nonmagnetic noble metal atoms are palladium (Pd) atoms, for example. The third thin film 44a thus is a palladium layer. Magnetic atoms form the fourth thin film 44b. Here, the magnetic atoms are cobalt (Co) atoms, for example. The fourth thin film 44b thus is a cobalt layer. Platinum (Pt) atoms may be employed in place of the palladium atoms. Iron (Fe) atoms may be employed in place of the cobalt atoms. Here, the second laminate unit 42 includes four layers of the second double-layer structure films 44. The cobalt layer, namely the fourth thin film 44b, having the thickness of 0.4 [nm] is overlaid directly on the surface of the palladium layer, namely the third thin film 44a, having the thickness of 0.6 [nm] in the individual second double-layer structure film 44.

When the write element, namely the single pole head, is opposed to the surface of the magnetic recording disk 14, a magnetic field leaking from the single pole head is applied to the first and second laminate units 41, 42 at the magnetic dots 26. The magnetic field is directed to the first and second laminate units 41, 42 in the perpendicular direction perpendicular to the surfaces of the first and second laminate units 41, 42. The magnetic field circulates from the soft magnetic underlayer 32 to the auxiliary magnetic pole of the single pole head. In this manner, the upward magnetization (directed outward in the perpendicular direction) or the downward magnetization (directed inward in the perpendicular direction) is established in every several magnetic pillars in the first and second laminate units 41, 42. Information is thus written. Since the total thickness of the tantalum cohering layer 37, the palladium basement layer 38 and the first and second laminate units 41, 42 is sufficiently reduced, the distance is reduced between the single pole head and the soft magnetic underlayer 32. As a result, the magnetization of a sufficient intensity is established in the first and second laminate units 41, 42. The first and second laminate units 41, 42 serve to reliably realize an accurate recording of information.

When the read element is opposed to the surface of the magnetic recording disk 14, a magnetic field leaking from the first and second laminate units 41, 42 is applied to the spin valve film or the tunnel-junction film. A variation in the electric resistance is induced in the spin valve film or the tunnel-junction film. The variation of the electric resistance enables the readout of information from the magnetic recording disk 14. In this case, since the saturation magnetization Ms and the anisotropic magnetic field Hk are appropriately adjusted in the first and second laminate units 41, 42, as described later, the information is reliably restored with accuracy.

Next, a description will be made on a method of making the magnetic recording disk 14. The substrate 31 is first prepared. The substrate 31 is set in a sputtering apparatus. A vacuum environment is established in the chamber of the sputtering apparatus. An iron tantalum carbide target is set in the chamber, for example. The soft magnetic underlayer 32 is formed on the surface of the substrate 31 within the chamber. The tantalum cohering layer 37 having the thickness of 2.0 [nm] and the palladium basement layer 38 having the thickness of 3.0 [nm] are formed on the surface of the soft magnetic underlayer 32 in this sequence. The sputtering apparatus is employed to form these layers. A tantalum target and a palladium target are likewise set in the sputtering apparatus. The pressure is set at 0.7 [Pa] approximately inside the chamber to form the palladium basement layer 38, for example. As a result, the crystal grains cohere to one another in the palladium basement layer 38. This results in a polycrystalline film having a continuous structure. On the other hand, when a higher pressure, such as 7 [Pa] is established inside the chamber, for example, the crystal grains are separated from one another in the palladium basement layer 38. This results in a polycrystalline film having a discontinuous structure.

Subsequently, the first laminate unit 41 is formed on the surface of the palladium basement layer 38. A single layer of the first double-layer structure film 43 is overlaid. A palladium layer having the thickness of 0.8 [nm] and a cobalt layer having the thickness of 0.2 [nm] are formed in this sequence. The sputtering apparatus is employed to form the layers. A palladium target and a cobalt target are set in the chamber of the sputtering apparatus. A predetermined waiting period or interval is ensured after the formation of the palladium layer prior to the formation of the cobalt layer. The sputtering rate is set smaller or slower for the formation of the palladium layer than the sputtering rate for the formation of the palladium basement layer 38.

The second laminate unit 42 is formed on the surface of the first laminate unit 41. Four layers of the second double-layer structure films 44 are overlaid. A palladium layer having the thickness of 0.6 [nm] and a cobalt layer having the thickness of 0.4 [nm] are alternately formed. The sputtering apparatus is employed to form the layers. A palladium target and a cobalt target are set in the sputtering apparatus. Palladium atoms and cobalt atoms are alternately emitted from the targets, respectively. A predetermined waiting period or interval is ensured between the formation of the adjacent layers.

As depicted in FIG. 5, a resist film 46 is thereafter formed in a predetermined pattern on the surface of the second laminate unit 42. The resist film 46 covers over regions corresponding to the magnetic dots 26. Photolithography technique is employed to form the resist film 46, for example. Ion implantation is effected on the surface of the second laminate unit 42 after the formation of the resist film 46. The voltage is controlled in an ion implanter to adjust the depth of implantation of ions. The first and second laminate units 41, 42 are transformed into the amorphous structure outside the contour of the resist film 46 uniformly by the depth of 5.0 nm from the surface of the second laminate unit 42. The amorphous structure serves to eliminate magnetism of the first and second laminate units 41, 42. In this manner, transformation regions, namely nonmagnetic bodies 27, are formed. The magnetic pillars are established right below the resist film 46. After the establishment of the magnetic pillars, the resist film 46 is removed.

The protection film 34 is then formed on the surface of the second laminate unit 42 on the first laminate unit 41. Chemical vapor deposition (CVD) process is employed to form the protection film 34, for example. The lubricating agent film 35 is applied to the surface of the protection film 34. Dipping process is employed to apply the lubricating agent film 35. In the dipping process, the substrate 31 is immersed in a solution containing perfluoropolyether, for example.

The inventor has observed the properties of the multilayered structure film 33. The tantalum cohering layer 37 having the thickness of 2.0 [nm] and the palladium basement layer 38 having the thickness of 3.0 [nm] were formed on a glass substrate in the observation. The first and second laminate units 41, 42 were formed on the palladium basement layer 38. The aforementioned first double-layer structure film 43 was utilized in the first laminate unit 41. Specifically, a cobalt layer having the thickness of 0.2 [nm] was overlaid on the surface of a palladium layer having the thickness of 0.8 [nm]. The aforementioned second double-layer structure film 44 was utilized in the second laminate unit 42. Specifically, a cobalt layer having the thickness of 0.4 [nm] was overlaid on the surface of a palladium layer having the thickness of 0.6 [nm]. Two different types of the first and second laminate units 41, 42 were prepared. The aforementioned first and second laminate units 41, 42 were utilized in the multilayered structure film 33 according to a first specific example. Specifically, a single layer of the first double-layer structure film 43 and four layers of the second double-layer structure films 44 were formed. Two layers of the first double-layer structure films 43 form the first laminate unit 41 in the multilayered structure film 33 according to a second specific example. Three layers of the second double-layer structure films 44 form the second laminate unit 42. Accordingly, the total thickness of the first and second laminate units 41, 42 were set equal to that of the first and second laminate units 41, 42 according to the first specific example (namely 5.0 [nm]). The waiting period was set at five (5) seconds for the formation of the multilayered structure films 33 according to the first and second specific examples. In addition to these two specific examples, two reference examples were prepared. Five layers of the second double-layer structure films 44 were formed on the palladium basement layer 38 in place of the first and second laminate units 41, 42 in the multilayered structure film 33 according to a first reference example. Five layers of the first double-layer structure films 43 were formed in place of the first and second laminate units 41, 42 in the multilayered structure film 33 according to a second reference example. Accordingly, the total thickness of the second double-layer structure films 44 and the total thickness of the first double-layer structure films 43 were set at 5.0 [nm]. The waiting period was set at five (5) seconds for the formation of the multilayered structure films 33 according to the first and second reference examples.

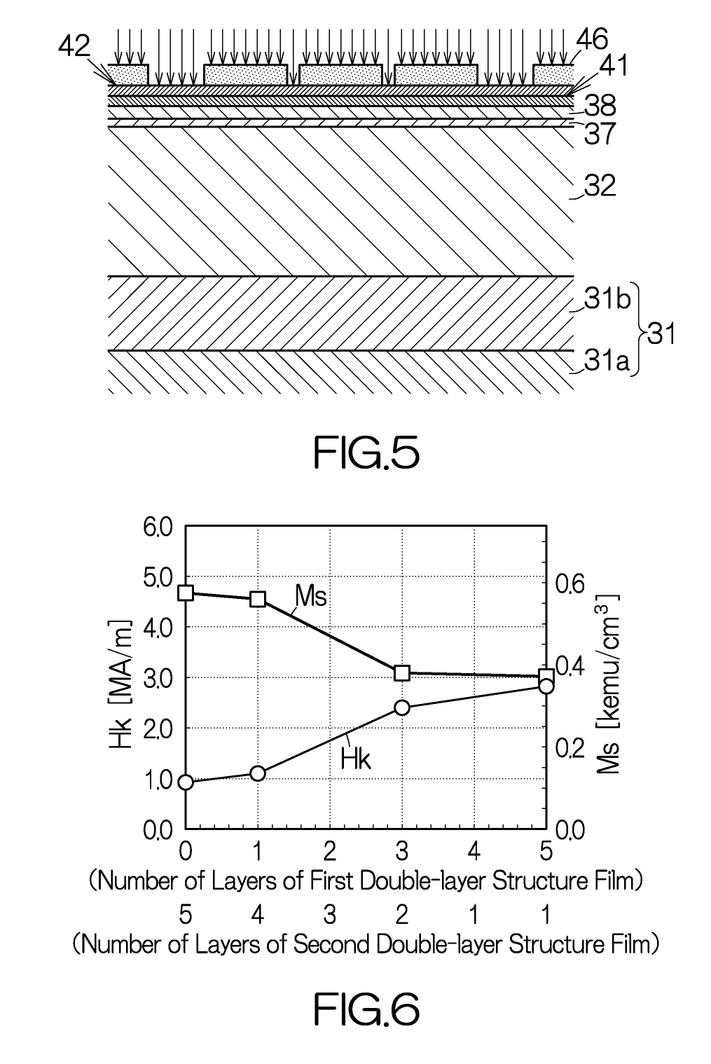

The inventor measured the saturation magnetization Ms and the anisotropic magnetic field Hk of the multilayered structure film 33 according to each of the first and second specific examples and the first and second reference examples. As depicted in FIG. 6, the multilayered structure film 33 according to the first reference example exhibited a considerably high saturation magnetization Ms in accordance with increase in the thickness of the cobalt layer, as compared with the multilayered structure film 33 according to the second reference example. On the other hand, the multilayered structure film 33 according to the first reference example exhibited a considerably low anisotropic magnetic field Hk as compared with the multilayered structure film 33 according to the second reference example. It has been confirmed that the saturation magnetization Ms and the anisotropic magnetic field Hk are adjusted by changing the numbers of the layers of the first and second double-layer structure films 43, 44. It has been discovered that the saturation magnetization Ms and the anisotropic magnetic field Hk are adjusted by changing the combination of the numbers of the layers even when the total thickness was set constant. Here, the thickness of 0.2 [nm] of the cobalt layer corresponds to the dimension (diameter) of cobalt atoms. It is difficult to control the thickness of the cobalt layer in a range equal to or smaller than 1.0 [nm]. However, it has been confirmed that desired values of the saturation magnetization Ms and the anisotropic magnetic field Hk can be obtained in a relatively facilitated manner if the saturation magnetization Ms and the anisotropic magnetic field Hk are adjusted by changing the numbers of the layers as described above.

Moreover, the inventor prepared the multilayered structure film 33 according to a third specific example. Five layers of the first double-layer structure films 43 form the first laminate unit 41 in this multilayered structure film 33. Likewise, five layers of the second double-layer structure films 44 form the second laminate unit. Accordingly, the total thickness of the first and second laminate units 41, 42 was set twice as large as that of the aforementioned first and second laminate units 41, 42 (namely 10.0 [nm]). The waiting period was set at two (2) seconds for the formation of the multilayered structure film 33 according to the third specific example. In addition to the third specific example, two reference examples were prepared. Five layers of the second double-layer structure films 44 were formed on the palladium basement layer 38 in the multilayered structure film 33 according to a first reference example in the same manner as described above. Five layers of the first double-layer structure films 43 were likewise formed in the multilayered structure film 33 according to a second reference example. The waiting period was set at two (2) seconds for the formation of the multilayered structure films 33 according to the first and second reference examples.

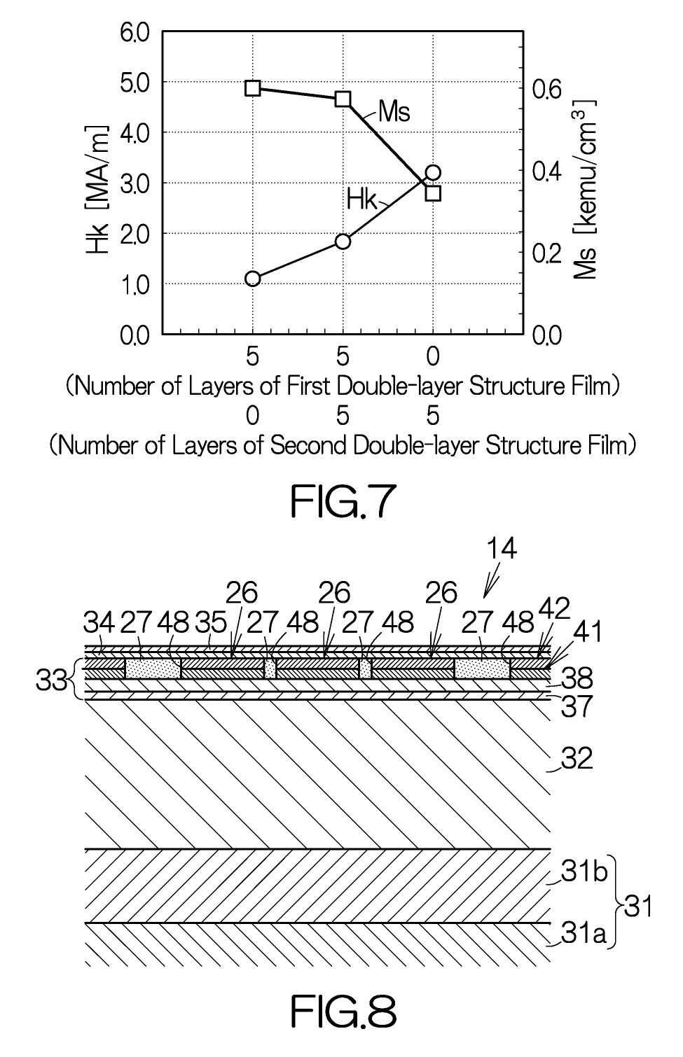

The inventor measured the saturation magnetization Ms and the anisotropic magnetic field Hk of the multilayered structure film 33 according to each of the third specific example and the first and second reference examples. As depicted in FIG. 7, the multilayered structure film 33 according to the first reference example exhibited a considerably high saturation magnetization Ms in accordance with increase in the thickness of the cobalt layer, as compared with the multilayered structure film 33 according to the second reference example. On the other hand, the multilayered structure film 33 according to the first reference example exhibited a considerably low anisotropic magnetic field Hk as compared with the multilayered structure film 33 according to the second reference example. It has been confirmed that the total saturation magnetization Ms and the total anisotropic magnetic field Mk can be adjusted by changing the combination of the first and second double-layer structure films 43, 44.

As depicted in FIG. 8, the nonmagnetic body 27 may be a nonmagnetic material embedded in spaces 48 formed in the first and second laminate units 41, 42. Reactive ion etching (RIE) process is employed to form the spaced 48, for example. The resist film 46 is formed on the surface of the second laminate unit 42 on the first laminate unit 41 prior to the reactive ion etching process in the same manner as described above. When the etching process is effected outside the contour of the resist film 46, the magnetic pillars are formed right under the resist film 46. The resist film 46 is then removed. The spaces 48 are filled with the nonmagnetic material around the magnetic pillars. Sputtering is employed to fill the spaces 48, for example. The nonmagnetic material on the magnetic pillars is removed. After the spaces 48 have been filled with the nonmagnetic material, the protection film 34 and the lubricating agent film 35 are formed on the surfaces of the magnetic pillars and the nonmagnetic material.

It should be noted that the first and second double-layer structure films 43, 44 may employ cobalt alloy including cobalt as a primary constituent and palladium alloy including palladium as a primary constituent in place of simple cobalt and palladium, respectively. Palladium may be replaced with platinum (Pt) or platinum alloy including platinum as a primary constituent. Either chrome (Cr) or boron (B) may be added to the cobalt alloy, for example. One bit does not need to be represented by plural magnetic pillars, and thus one bit may be represented by one magnetic pillar.

What is claimed is:

1. A multilayered structure film comprising:
a first laminate unit including a first thin film and a second thin film laminated on each other, the first thin film having a first thickness and made of nonmagnetic noble metal atoms, the second thin film having a second thickness and made of magnetic atoms or a magnetic alloy; and
a second laminate unit overlaid on the first laminate unit, the second laminate unit including a third thin film and a fourth thin film laminated on each other, the third thin film having a third thickness different from the first thickness, the third thin film made of the nonmagnetic noble metal atoms, the fourth thin film having a fourth thickness different from the second thickness, the fourth thin film made of the magnetic atoms or the magnetic alloy.

2. The multilayered structure film according to claim 1, wherein the first laminate unit includes plural pairs of the first and second thin films.

3. The multilayered structure film according to claim 1, wherein the second laminate unit includes plural pairs of the third and fourth thin films.

4. The multilayered structure film according to claim 1, wherein the magnetic atoms are cobalt atoms, and the magnetic alloy is a group of atoms including cobalt atoms as a primary constituent.

5. The multilayered structure film according to claim 4, wherein either the second thickness or fourth thickness is set equal to size of either the magnetic atoms or the atoms contained in the group.

6. A perpendicular magnetic storage medium comprising:
a substrate;
a soft magnetic underlayer overlaid on a surface of the substrate;
a basement layer overlaid on a surface of the soft magnetic underlayer;
a first laminate unit overlaid on the basement layer, the first laminate unit including a first thin film and a second thin film laminated on each other, the first thin film having a first thickness and made of nonmagnetic noble metal atoms, the second thin film having a second thickness and made of magnetic atoms or a magnetic alloy; and
a second laminate unit overlaid on the first laminate unit, the second laminate unit including a third thin film and a fourth thin film laminated on each other, the third thin film having a third thickness different from the first thickness, the third thin film made of the nonmagnetic noble metal atoms, the fourth thin film having a fourth thickness different from the second thickness, the fourth thin film made of the magnetic atoms or the magnetic alloy.

7. The perpendicular magnetic storage medium according to claim 6, wherein the first laminate unit includes plural pairs of the first and second thin films.

8. The perpendicular magnetic storage medium according to claim 6, wherein the second laminate unit includes plural pairs of the third and fourth thin films.

9. The perpendicular magnetic storage medium according to claim 6, wherein the magnetic atoms are cobalt atoms, and the magnetic alloy is a group of atoms including cobalt atoms as a primary constituent.

10. The perpendicular magnetic storage medium according to claim 9, wherein either the second thickness or fourth thickness is set equal to size of either the magnetic atoms or the atoms contained in the group.

11. The perpendicular magnetic storage medium according to claim 6, wherein magnetic pillars are formed in the first laminate unit and the second laminate unit, the magnetic pillars being arranged in recording tracks isolated from one another with a nonmagnetic body, the magnetic pillars being isolated from one another with the nonmagnetic body within individual ones of the recording tracks.

12. The perpendicular magnetic storage medium according to claim 11, wherein the nonmagnetic body is made of nonmagnetic material filled in spaces defined in the first laminate unit and the second laminate unit.

13. The perpendicular magnetic storage medium according to claim 11, wherein the nonmagnetic body is a transformation region formed in the first laminate unit and the second laminate unit based on ion implantation.

14. A storage device comprising:
a storage medium; and
a head slider opposed to a surface of the storage medium, wherein
the storage medium includes:
a substrate;
a soft magnetic underlayer overlaid on a surface of the substrate;
a basement layer overlaid on a surface of the soft magnetic underlayer;
a first laminate unit overlaid on the basement layer, the first laminate unit including a first thin film and a second thin film laminated on each other, the first thin film having a first thickness and made of nonmagnetic noble metal atoms, the second thin film having a second thickness and made of magnetic atoms or a magnetic alloy; and
a second laminate unit overlaid on the first laminate unit, the second laminate unit including a third thin film and a fourth thin film laminated on each other, the third thin film having a third thickness different from the first thickness, the third thin film made of the nonmagnetic noble metal atoms, the fourth thin film having a fourth thickness different from the second thickness, the fourth thin film made of the magnetic atoms or the magnetic alloy.

15. The storage device according to claim 14, wherein the first laminate unit includes plural pairs of the first and second thin films.

16. The storage device according to claim 14, wherein the second laminate unit includes plural pairs of the third and fourth thin films.

17. The storage device according to claim 14, wherein the magnetic atoms are cobalt atoms, and the magnetic alloy is a group of atoms including cobalt atoms as a primary constituent.

18. The storage device according to claim 14, wherein magnetic pillars are formed in the first laminate unit and the second laminate unit, the magnetic pillars being arranged in recording tracks isolated from one another with a nonmagnetic body, the magnetic pillars being isolated from one another with the nonmagnetic body within individual ones of the recording tracks.

19. The storage device according to claim 18, wherein the nonmagnetic body is made of nonmagnetic material filled in spaces defined in the first laminate unit and the second laminate unit.

20. The storage device according to claim 18, wherein the nonmagnetic body is a transformation region formed in the first laminate unit and the second laminate unit based on ion implantation.
